(19) United States
(12) Patent Application Publication
(10) Pub. No.: US 2005/0112271 A1
(43) Pub. Date: May 26, 2005

(54) Meat alternative

(76) Inventor: Ron Pickarski, Boulder, CO (US)

Correspondence Address: SHERIDAN ROSS PC, 1560 BROADWAY, SUITE 1200, DENVER, CO, 80202, US

(21) Appl. No.: 10/723,038

(22) Filed: Nov. 26, 2003

(51) Int. Cl. A23J 1/00

(52) U.S. Cl. 426/656

(57) ABSTRACT

A meat alternative, having from about 65% to about 85% by weight of a hydrated plant protein source and from about 15% to about 35% by weight of a meat protein source, is formed by mechanically or chemically extracting collagen into a slurry of the meat and water, the collagen supporting the plant protein in the final product to create a pleasing texture and flavor. Dietary fiber is optionally added to retain moisture and increase nutritional value of the meat alternative. Additional gelling agents may be added to increase support for the plant protein, enhancing the product's texture. Optionally, additional plant or animal based flavorings are added to enhance the flavor and coloring agents may be added to enhance the visual aspects of the product. Nutraceuticals may be added to enhance the nutritional value.

### FIELD OF THE INVENTION

The invention relates to food products comprising largely plant proteins and smaller quantities of meat proteins as a meat alternative for use alone or in combination with other ingredients for culinary use.

### BACKGROUND OF THE INVENTION

It is well known in food preparation and in the food industry to add extenders to meat and meat products, such as ground beef, to extend the use of the meat for preparation of foodstuffs such as meat patties, sausages and the like. Typically, the extenders are plant in origin, such as grain flakes and other fiber-enhancing materials and plant proteins, such as soy protein. Typically, less expensive extenders are added to bulk up or stretch the use of the meat, and thus reduce the overall cost of the food preparation, often acting to reduce the nutritional value of the meat.

Further, it is known that reduction in the consumption of meat or flesh proteins, with a concomitant increase in consumption of whole grains and plant based products may be desirable to improve overall health, in many populations. As early as the 1960's soy proteins were added to meat as an extender or bulking agent to reduce meat cost. As soy emerged as a nutrient-dense, heart-healthy protein, its role as a meat extender has evolved into a nutrient-dense alternative protein.

Typically, the addition of vegetable or plant based protein does not enhance the organoleptic quality of the meat. As the percentages of plant material increase, the overall functionality and organoleptic qualities of the meat become compromised. A usual ratio of plant protein to meat is 25:75. The product relies upon the large percentage of meat for its flavor and gelling properties, which allow the product to be formed into patties, sausages and the like. The vegetable or plant-based material neither imparts structure nor flavor to the final product, merely acting to extend the bulk of the meat.

Meat extenders are also known which incorporate additional nutrients with the typical plant proteins for use in certain populations. U.S. Pat. No. 6,419,977 to Born discloses the use of a four-component extender of meat which includes whey protein concentrate, maltodextrin, a starch and a non-fat dry milk to provide a reduced-fat meat particularly suitable for individuals with nutrient absorption disorders or reduced gastrointestinal tolerance. Applicant believes that the whey acts to break down the protein to aid digestion and absorption. Once the extender is mixed into a ground meat, the resulting product must be shaped and frozen in order to create ice-crystals in the meat which Born hypothesizes are required for forming a cohesive meat product.

Infusions of meat with soy are known, in which the plant protein is mechanically ground or extensively processed into the meat, however, the function of the soy remains as that of an extender, adding only to the bulk and not to the structure.

U.S. Pat. No. 5,626,899 to Payne et al. teaches a process for making plant-based meat extenders using soy protein isolate, hydrated and chopped. A plant-protein and/or complex carbohydrate is added and the mixture is chopped again. After cooling, the composition is again chopped, at which time it becomes a crumble, which is used in combination with meat as an extender. Payne et al. refer to studies which indicate that approximately 20% soy protein used in combination with ground meat to form meat patties is an acceptable ratio of meat to protein crumble. Beyond this, flavorings must be added to offset the dilution effect of the meat flavor.

U.S. Pat. No. 6,582,746 to Altemueller et al. teaches a meat product which comprises 35 to 70% meat, 3 to 30% unrefined plant protein, preferably and described only as being soy based plant proteins, and 25 to 55% water. Altemueller et al. teach that refined or conventional plant flours grits and meals are frequently not as effective in food ingredient applications as are unrefined plant proteins due to their reduced protein concentrations compared to plant protein concentrates or isolates and to their relatively high raffinose and stachyose content. The patent teaches preparation of a particular unrefined plant protein, typically from soy, that satisfies the protein, raffinose and stachyose content required for their invention. The resulting product is shaped and expeditiously flash frozen, to prevent formation of ice crystals. Animal protein comprises the largest portion of the meat product and, although disclosed to be deboned and defatted and having little inherent structure, Applicant believes that it provides a significant contribution, due to its mass, to the overall texture of the product. The denatured soy protein is disclosed as having a significant, refrigerated gel strength and is relied upon to provide a firm structure to the meat emulsion.

Clearly, what is desired is a meat alternative that relies largely on plant protein thus reducing the demand for costly meat protein. Further, it is desirable that the plant protein used be either conventional refined plant protein, plant protein concentrates, plant protein isolates or unrefined plant proteins so as to take advantage of a large number of already commercially available plant protein products. Even more desirable is that the meat alternative produced using largely plant protein have an organoleptically pleasing texture, bite and flavor, consistent with a variety of animal proteins, including but not limited to beef, pork, chicken, seafood and fresh and saltwater fish.

### SUMMARY OF THE INVENTION

The composition of the novel meat alternative described herein utilizes a relatively minor percentage of meat or flesh protein to act as a functional ingredient for supporting a larger percentage of plant protein, thus creating a unique meat alternative that can be used alone or in combination with other ingredients for culinary usage.

A meat or flesh protein source is used to create a matrix, rich in collagen and optionally-added gelling agents, which act to support the plant protein when combined with a larger percentage of a source of plant protein to produce a texture which is similar to traditional meat textures. Rather than act merely as an extender, the plant protein comprises the largest percentage of the meat alternative. The meat alternative makes possible and serves as the foundation for a wide variety of culinary uses.

The overall texture of the product can be altered by combining meat protein sources having different protein and collagen content with plant protein sources having different protein contents. Meat protein sources, such as aged meat or shank meat combined with plant protein sources, such as soy isolates having a high protein content, results in a firmer texture than combining meat protein sources and plant protein sources having lower protein concentrations.

Optionally, dietary fiber, nutraceuticals, plant or animal based flavorings can be super-added to enhance the nutritional quality of the meat alternative and to create a pleasing organoleptic profile. Fat content can be adjusted, either by the choice of the cut of meat used in the preparation of the primary meat matrix or by the addition of fats to further add to the taste, texture and the products ability to be extruded into a variety of final products such as sausages, cutlets and the like.

Texture may be further modified by adding strands of meat to the product after the addition of the plant protein or by extruding the meat alternative in a layering technique sufficient to mimic that of conventional meat cuts such as chicken breast and beef steak or roasts.

The meat alternative provides a nutrient dense flesh-protein enhanced plant protein that satiates the desire for meat while simultaneously addressing the need for increased nutrition in combination with proteins.

Therefore, in a broad aspect of the invention, a meat alternative is produced comprising a primary animal protein matrix comprising a source of animal protein in a range from about 15% by weight to about 35% by weight in water, the water being from about 38% by weight to about 46% by weight, the animal protein and water being formed into a slurry for extracting collagen from the meat protein; and dehydrated plant protein source, sufficient when hydrated in the water to form a hydrated plant protein source in a range from about 65% by weight to about 85% by weight, wherein the extracted collagen in the primary animal protein matrix acts to support the plant protein to produce an organoleptically pleasing texture and the animal protein further acts to flavor the meat alternative.

In a preferred embodiment of the invention, the plant protein source is 100% soy protein or can optionally be a mixture of plant protein sources of which preferably 50% is soy protein. Gluten flour, hemp and other plant protein sources may be used as well and particularly in combination with the soy protein source. In the case of ethnically diverse applications, bean protein powders can be added to add distinctive flavoring. The flesh or animal protein source can be a variety of animal protein sources including but no limited to beef, chicken pork and fish. The meat used is boneless and preferably has the skin removed to prevent addition of additives and chemicals fed to animals which tend to accumulate in the skin.

Advantageously, and particularly in the case of beef, older carcasses not traditionally thought of as being prime sources of beef cuts are best suited to the instant invention due to the increased collagen content. Further, any cuts of animal flesh having higher collagen concentrations, such as the shank, are preferred.

In societies concerned with the implications of high meat consumption and its association with diseases, such as coronary artery disease and the like, the present invention provides a solution that decreases overall meat consumption while providing a healthy plant-based alternative which continues to satisfy the desire for meat flavor and texture.

### DETAILED DESCRIPTION OF THE PREFERRED EMBODIMENT

A meat alternative is produced by mixing a meat matrix or emulsion with a plant-based protein source. The percentage of meat or flesh protein source ranges from about 15% by weight to about 35% by weight, while the hydrated plant protein source content ranges from about 65% by weight to about 85% by weight. The percentage of plant protein source is significantly greater than that found in the prior art, without sacrificing texture or nutritional content. Additional flavoring may be added, particularly at lower concentrations of flesh protein source to overcome the organoleptic interference as a result of the higher concentration of plant protein source. The resulting meat alternative can be shaped, or extruded or the like to provide additional texturing, and used alone or in combination with other ingredients including meats and vegetables for culinary purposes.

The primary function of the meat matrix is that of imparting a specific meat-like structure and flavor profile, that is, an organoleptically pleasing texture and flavor of a particular flesh protein, such as beef, pork, chicken, fish or seafood, into a plant protein source. This may be achieved using mechanical protein extraction techniques or chemical protein extraction or a combination of both. The animal protein is utilized as the primary stabilizing, gelling and flavor-enhancing functional ingredient for the plant proteins.

The meat matrix is formed by mechanically combining the meat source with water, such as in a food processor, such as a vertical cutter/mixer (VCM), available from AB Hällde Maskiner, P.O. Box 1165, SE-164 26 Kista, Sweden. The meat source is first cut into chunks or coarsely ground to approximately ¼″. The water comprises from about 38% by weight to about 50% by weight and preferably about 40% by weight of the total weight of the final product and is also used to hydrate the dehydrated sources of plant protein which are added after the meat matrix is formed. The amount of water used in the meat matrix varies with the amount of flesh protein source used. The highest percentages of water are typically found with lower percentages of flesh protein source. The meat source is pulverized in the water, sufficient to result in a mechanical extraction of the protein, including collagen, from the meat source.

Typically, the VCM is run for about 3 minutes at high speed to form a slurry. Advantageously, the meat source selected for use in the invention may be high collagen meats such as found in older animals and in cuts not desired for other uses. If the final product is being frozen for future use, the ingredients and resulting meat matrix should be maintained at a temperature below 35° F. (2° C.) during preparation, to ensure the safety of the product. If the product is being cooked immediately, the preparation temperatures may vary from 35° F. to 55° F. (2° C. to 20° C.).

The dehydrated source of plant protein is added to the meat matrix in amounts sufficient to be in the range of about 65% to about 85% by weight, once hydrated in the water in the matrix. The meat matrix and source of plant protein are mixed until the meat alternative forms into a ball which can be frozen as is, shaped or extruded and frozen, or cooked immediately. The process of preparing the meat alternative is complete with the integration of the meat matrix into the source of the plant protein.

In order to enhance the texture of the final product, when using the meat alternative to replace cuts of meats such as a beef roast or a chicken breast, strands of meat may be added to the matrix prior to the addition of the plant protein source to provide a traditional muscle meat texture or the meat alternative may be extruded in a layering technique to create a similar texture. Other products such as sausage, bologna and the like may require less manipulation to provide a traditional texture and may be simply extruded.

A functional ingredient in the meat matrix is the collagen which is an insoluble fibrous protein that occurs in vertebrates as the chief constituent of connective tissue fibrils and in bones and yields a gelatin or glue-like texture on prolonged heating with water. Collagen is an elongated protein formed from tropocollagen which forms helical strands which self-assemble into extremely strong microfibrils which are bonded intermolecularly to form the collagen. When collagen fibers form sheets or cables, it is seen macroscopically in the meat and may be detected as “gristle” if not gelatinized during cooking of the meat. Collagen is the most abundant protein in the animal body and is an important factor in meat toughness. Animal carcasses, particularly beef, are graded by age, mainly because of age-related changes in the collagen that cause meat from older animals to have more developed collagen and be tougher.

Advantageously, aged carcasses, high collagen containing cuts such as shank and more active muscle meats, which are not traditionally thought to be preferred for human consumption, are ideal for use in the meat matrix of the instant invention as they impart larger amounts of collagen which result in a higher grade of structure to the plant proteins.

Optionally, and particularly when less tough cuts having less collagen are used, a food phosphate such as trisodium pyrophosphate or tetrasodium pyrophosphate may be added to chemically assist in extracting available muscle proteins, particularly collagen, from the meat source. If used at all, food phosphate is added in a range of about 1% by weight or less.

The meat or flesh protein source from a wide variety of animal species can be used, including but not limited to, beef, pork, chicken, lamb, fish and seafood. All meat used is boneless. All seafood is skinned and boned. Skin, such as on chicken, may be used, however it is not recommended due to the high fat content and it's ability to assimilate and hold any chemicals or hormones fed to the animal.

One plant-based protein source used in the invention is soy, which contains significant levels of isoflavonoids. Soy protein concentrates typically comprise approximately 70% protein and soy protein isolates typically comprise approximately 90% protein. Both soy concentrates and soy isolates may be used. The invention however is not limited to the use of soy as the sole plant protein source. Optionally, wheat, hemp, bean or other plant protein sources may be combined with soy, particularly if required to alter the final texture and organoleptic profile of the meat alternative. Preferably, the soy protein source comprises at lest 50% of the total source of plant proteins. Hemp, which typically has a protein concentration of approximately 48%, if added to the soy protein source, may additionally provide enhanced nutritional benefits due to its high omega fatty acid content.

The combination of different meat protein sources with different plant protein sources results in a variety of possible textures for the meat alternative. For example, meat protein sources having high protein and collagen concentrations when mixed with plant protein sources having a high protein content results in a firmer, tougher bite. Conversely, meat and plant protein sources having lower concentrations of protein, when combined, result in a softer bite.

If extrusion is to be used to form the final product, soy concentrates, and soy isolates are preferred sources of plant proteins as they provide a consistency and texture that is easier to mechanically process.

Additional ingredients may be added to the meat matrix to enhance gelling and moisture retention, assist in achieving a desired texture, flavor or color and add to the nutritional value of the final product.

Specifically, gelling agents such as carageenan, konjac, starches and gelatins may be added, particularly for use with lower-collagen containing meat protein sources, to assist in providing structure for the plant-based proteins. Gelatins having an appropriate aid base may be used, particularly for the production of cold cuts. Typically, gelling agents are added in a range from about 0% to about 2% by weight, depending upon the meat source used.

In an embodiment of the invention, transglutaminase, such as Activa™TG, available from Ajinmoto USA, which acts to cross-link peptides, may be used as a gelling agent to cross-link the plant and flesh proteins.

Optionally, secondary animal proteins such as whey protein or egg albumen can be added in re-hydrated percentages as high as 25% by weight of the soy protein when the remainder of the plant protein source is soy. Re-hydrated whey or egg protein act as a complimentary gelling agent in the meat matrix, due to their strong protein structures which enhances the function of the meat matrix to support the plant proteins. Use of secondary animal proteins reduces the amount of flesh protein needed to build structure into the plant proteins.

Dietary fiber, such as oat fiber, may be added to assist in moisture retention, resulting in a pleasing bite or mouth-feel. Further, the dietary fiber adds to the overall nutritional content of the final product, adding to the functionality of the product.

Fat may be added, in addition to the fat which is found in the meat itself, depending upon the desired end product. Preferably, fat is added in a range from about 0 to about 10% by weight to enhance flavor and texture. If the meat alternative is to be used to create a sausage as the final product, a fat content up to about 20% to 30% by weight may be desired in order to achieve a desired texture and flavor. Where extrusion is required to form a particular end product, the percentage of fat must be adjusted accordingly, as extrusion is particularly affected by the fat content.

Flavor enhancers and coloring agents may be added during preparation of the meat matrix to augment the natural flavor of the meat being used. The organoleptic profile of the specified meat is enhanced through traditional meat-based flavors for non-kosher products and plant-based or reactive flavorings for kosher meat products. Where a particular flavor, such as for use in Mexican or Asian cuisine, is required, addition of particular plant protein sources such as instant bean powders, which have a characteristic flavor, can be substituted for part of the soy protein concentrates or isolates to create a meat alternative having a distinctive bean flavor. Typically, in these cases, the soy protein source is maintained in an amount being at least 50% by weight of the total plant protein source to maintain the overall texture.

Sodium levels vary according to specific flavor systems used and are factored into the overall sodium level desired in the meat alternative. When the flavoring used contains high levels of sodium, little or no additional sodium is added.

Optionally, ingredients such as defatted flax can be added to provide color and fiber. Dark flax may be used to provide coloring for red meat alternatives, such as beef, and white flax may be used in white meat alternatives, such as chicken.

Nutraceuticals may also be added to enhance the nutritional content of the meat alternative. Any nutraceutical ingredient added must be heat tolerant to 180° F. (80° C.), as the meat alternative must be cooked to at least 180° F. to maintain safety of the product for human consumption.

Alternatively, in a low fat embodiment of the invention, a product known as lean finely textured beef or LFTB, developed by Joseph G. Sebranek, Professor of Animal Science and Professor of Food Science and Human Nutrition, University of Iowa and Ying He, Research Assistant, University of Iowa, disclosed in Journal of Food Science 1996:61:1155 and incorporated herein by reference, may be used as the animal protein source. LFTB is derived from beef-fat trimmings characterized as high in total protein, containing more serum and connective tissue proteins than myofibrillar proteins found in muscle meat. Traditionally, LFTB has been found to be less functional in processed meats, resulting in lower yields and a softer texture. Appropriate use of sodium chloride, sodium tripolyphosphate, k-carrageenan, or isolated soy protein however, may be used to achieve sufficient stability and yields to permit preparation of frankfurters using the LFTB. Thus, the softer-textured LFTB may be advantageously used for high-protein, low-fat products where excessive toughness or firmness is undesirable.

In use, much like traditional meat products, the meat alternative may be used alone, such as formed or extruded into roasts, cutlets, steaks, patties, cold cuts, sausages or hotdogs which can be cooked and eaten as such, or the meat alternative can be further mixed with other plant or animal products, such as tofu, grains, vegetables, ground meat or the like in casseroles, loaves, burgers, patties and sausages.

Advantageously, due to the high plant protein concentration in the meat alternative, it can be browned at lower temperature to achieve a caramelized flavor, while still retaining sufficient moisture to be palatable.

### EXAMPLES

### Example A

Meat alternatives were prepared according to the embodiments of the invention, resulting in a variety of organoleptic profiles suitable for preparation of products used as alternatives to traditional meat products.

| | Meat | Hydrated Vegetable | | | | | | |
|---|---|---|---|---|---|---|---|---|
| | Source | protein Source | Gel | Flavor/color | Fiber | Fat | TPP* | |
| Type | wt % | wt %⁺ | wt % | wt % | wt % | wt % | wt % | |
| Beef** | 20% | 69.9% (26; 43.9) | 0.3% | 4.2% | 0% | 5.6% | 0% | |
| Beef** | 25.9% | 62.9% (17.5; 45.4) | 0.6% | 3% | 1.7% | 5.8% | 0% | Soft bite |
| Chicken*** | 24.5% | 62.7% (22.5; 40.2) | 2% | 2% | 1% | 4.9% | 1% | |
| Chicken*** | 26.5% | 52.3% (12.9; 35.4) | 0.8% | 7.8% | 0.6% | 12.1% | 0.6% | Soft bite warm |
| | | | | | | | | Firm bite - cold |
| Beef**** | 25% | 60.7% (16.9; 43.8) | 0% | 7% | 1.1% | 5.6% | 0.6% | Firm |
| | | | | | | | | Rich hue |
| Catfish - | 25.9% | 63% (17.5; 45.5) | 0.6% | 2.9% | 1.2% | 5.8% | 0.6% | Firm moist |
| skinned and | | | | | | | | |
| boned | | | | | | | | |

*Tri-sodium Pyrophosphate
**Boneless beef shank ground to ⅛ inch
***Chicken breast - not chopped
****Ground beef 80-20 lean
⁺(wt % dehydrated plant protein; wt % water) in total weight of meat alternative

### Example B

After formation of the meat alternative, the meat alternative may e used in combination with other animal or plant based proteins, vegetables and the like to create culinary dishes.

For example, 25-50% of the meat alternative was mixed with 50-75% cooked beans with additional seasonings to create bean burgers, bean loaves, sausages or the like. Similarly, 25-50% of the meat alternative can be mixed with traditionally used ground meats such as beef, chicken or turkey to produce burgers, patties, sausages or loaves.

1. A meat alternative comprising:
a primary animal protein matrix comprising an animal protein source in a range from about 15% by weight to about 35% by weight and water, from about 38 by weight to about 46% by weight, the animal protein source and water being formed into a slurry for extracting collagen from the meat protein; and
a dehydrated plant protein source sufficient, when hydrated in the water in the primary protein matrix, to form hydrated plant protein source in a range from about 65% by weight to about 85% by weight
wherein,
the extracted collagen in the primary animal protein matrix acts to support the plant protein to produce an organoleptically pleasing texture and
the animal protein source further acts to flavor the meat alternative.

2. The meat alternative as described in claim 1 wherein the slurry is formed mechanically so as to extract the collagen from the animal protein source.

3. The meat alternative as described in claim 2 further comprising a sodium phosphate to chemically aid in extracting collagen from the animal protein source into the slurry.

4. The meat alternative as described in claim 3 wherein the sodium phosphate is tetrasodium pyrophosphate.

5. The meat alternative as described in claim 3 wherein the sodium phosphate comprises from about 0% by weight to about 1% by weight.

6. The meat alternative as described in claim 1 further comprising a gelling agent so as to aid the collagen in supporting the plant protein to form the organoleptically pleasing texture.

7. The meat alternative as described in claim 6 wherein the gelling agent comprises from about 1% to about 2% by weight.

8. The meat alternative as described in claim 6 wherein the gelling agent is selected from a group comprising konjac, carageenan, starches, gelatins and transglutaminase.

9. The meat alternative as described in claim 1 further comprising dietary fiber so as to provide additional nutritional value and to retain moisture whereby the organoleptically pleasing texture is enhanced.

10. The meat alternative as described in claim 9 wherein the dietary fiber comprises from about 1% to about 2% by weight.

11. The meat alternative as described in claim 1 further comprising fat in a range from about 5% to about 30% by weight whereby the organoleptically pleasing texture and the flavor are enhanced.

12. The meat alternative as described in claim 11 wherein the fat is in a range from about 5% to about 10% by weight.

13. The meat alternative as described in claim 1 wherein the plant protein source is selected from a group consisting of soy protein concentrates, soy protein isolates, soy flour, gluten, hemp and bean powders and mixtures thereof.

14. The meat alternative as described in claim 1 further comprising additional meat-based flavoring.

15. The meat alternative as described in claim 1 further comprising additional plant-based flavoring.

16. The meat alternative as described in claim 14 wherein the additional meat-based flavoring is in a range from about 2% to about 10% by weight.

17. The meat alternative as described in claim 14 wherein the additional plant-based flavoring is in a range from about 2% to about 10% by weight.
